(19) United States
(12) Patent Application Publication
(10) Pub. No.: US 2010/0269733 A1
(43) Pub. Date: Oct. 28, 2010

(54) METALLIC PIGMENTS, METHOD FOR THE PRODUCTION THEREOF AND USE THEREOF AND COATING POWDER

(76) Inventor: Hans-Jörg Kremitzl, Eckental (DE)

Correspondence Address: OSTROLENK FABER GERB & SOFFEN, 1180 AVENUE OF THE AMERICAS, NEW YORK, NY, 100368403, US

(21) Appl. No.: 12/808,816

(22) PCT Filed: Dec. 18, 2008
(86) PCT No.: PCT/EP2008/010840

§ 371 Date: Jun. 24, 2010

(30) Foreign Application Priority Data
Dec. 19, 2007 (DE) 10 2007 061 701.3

(51) Int. Cl. C09C 1/64; C09C 1/66

(52) U.S. Cl. 106/404; 106/403

(57) ABSTRACT

The present disclosure relates to metallic effect pigments with a platelet-shaped metallic substrate, the metallic effect pigments having at least one metal oxide layer, and the surface of the metal oxide layer having at least one surface modifier which comprises fluoroalkyl and/or fluoroaryl groups. It further relates to a method for producing the metallic effect pigments of the invention, and to their use in powder coatings, especially in powder coatings produced by mixing methods, and also to the use of these powders. Lastly the disclosure also relates to powder coatings.

The invention relates to metallic effect pigments for preferred use in powder coatings. The invention further relates to a method for producing these metallic effect pigments and to their use in powder coatings, to a powder coating, and to the use of these powder coatings.

Metallic effect pigments provide applications, such as paints and coatings, for example, with lustrous, brilliant effects, and fulfill functional requirements.

A key requirement of metallic effect pigments is the directed reflection of light at parallel-oriented pigment platelets. The peculiarity of applications with this kind of pigmentation is the pronounced angular dependence of the optical impression they feature; in other words, as the viewing angle changes, there are also changes in the lightness and, occasionally, in the color shade of the application as well.

Powder coatings are finding continually increasing use as solid and solvent-free coating materials in industrial mass production for the coating of electrically conductive and temperature-stable materials. The powder coatings, which are used as a primer or one-coat topcoat, are almost completely recyclable.

The powder coatings, which are eco-friendly and have diverse possible uses, comprise binders, pigments, fillers, and crosslinkers, and optionally additives as well.

Powder coatings are present in a finely divided form, and are generally applied electrostatically to various substrates and cured by baking or by radiation energy.

For the production of powder coatings, in a conventional mixing method, the raw materials for the coating, optionally after premixing in a solids mixer, are introduced into an extruder and homogenized in the melt at 80 to 140° C. The extrudate discharged from the extruder, cooled, and comminuted is subjected to an intense milling operation until the desired particle size is present.

For the pigmentation of powder coatings use is made, in addition to commercial chromatic pigments, of effect pigments produced by conventional ball mill grinding or by chemical-physical methods (PVD or CVD methods), such as, for example, platelet-shaped metallic effect pigments made of aluminum, copper, copper-zinc alloys or zinc.

The use of commercial platelet-shaped metallic effect pigments in powder coatings produced by mixing methods is problematic in that the shearing forces which act on the pigment platelets in the course of the extrusion and grinding operation can result in damage to or destruction of the pigment platelets, thereby possibly causing negative impairment of, in particular, the gloss, and hence also of the optical qualities of the applications pigmented with these pigments.

In order to prevent this, for example, the effect pigments used to pigment powder coatings are not mixed into the base powder coating until after the grinding procedure. A significant disadvantage of this powder coating production method, which is known as the dry-blend method, is the possible separation of pigment and powder coating during application of the coating material, owing to the different charging characteristics of the individual coating constituents.

The consequence of this depletion or accumulation of pigment in the course of powder coating application is an irregular optical effect in the coated article. Moreover, the separation of pigment and binder makes it impossible fully to recover and re-use the environmentally damaging “overspray”, as it is called.

A further method for powder coating production is that known as the bonding method, in which the pigment is fixed to the particles of the basecoat by heating. The production of bonding powder coatings of this kind that can be used for high-grade optical coatings, however, is relatively costly.

The powder coatings that are presently the most cost-effective are produced by means of mixing methods. For such methods, the pigments are mixed together with all of the other raw materials, extruded, and ground. With this powder coating production operation, there is no need for the otherwise necessary worksteps of “dry blending” and/or “bonding”.

Powder coatings produced by mixing methods are pigmented with metallic effect pigments using, for example, dust-free gold-bronze and aluminum pigment preparations, which are traded commercially under the name “PowderSafe®” by ECKART GmbH 91235 Velden. Although the one-coat finishes pigmented with these platelet-shaped metallic effect pigments have very good metallic optical qualities, they are not sufficiently abrasion-stable for specific purposes, and so the applications pigmented with these commercial metallic effect pigments must additionally be protected from mechanical and/or chemical influences by a clearcoat coating. The reason for this is that the metallic effect pigments introduced in the powder coating have leafing properties—that is, during the baking procedure, the pigment platelets float in the coating film and undergo alignment in the region of the film surface. These pigments, however, prevent effective attachment of the clearcoat to the basecoat, meaning that the powder coating is no longer resistant to abrasion.

For powder coating production by the bonding or dry-blend method, moreover, a large number of surface-coated/-modified effect pigments are used. These commercial pigments are, however, not resistant to damage and/or destruction due to the shearing forces that occur in the course of extrusion/grinding.

Effect pigments of this kind are traded, for example, by Merck under the name Iriodin®. These pearlescent pigments comprise mica platelets coated with metal oxides.

The Merck company also has surface-modified pearlescent pigments on the market, which are coated with a polymer compound and are described in DE-A 43 17 019, for example.

Also employed for the pigmentation of powder coatings are coated Al₂O₃ platelets, bismuth oxychloride (BiOCl), aluminum flakes, Variochrom® or Paliochrom® pigments from BASF, LCP pigments (liquid crystal polymer pigments), and coated glass flakes or multilayer pigments.

Also known from EP 1 174 474 B1 is the use of low molecular mass polyethylene or polypropylene coated SiO₂ platelets or aluminum flakes.

In contrast, EP 1 558 684 B1 relates to a silane-modified pigment composition for use in metalized paints, printing inks, and plastics material. It is produced by grinding atomized aluminum powder by the known Hall process in the presence of silane instead of the fatty acids typically employed in that milling process. These aluminum pigments can be used in both aqueous and solventborne coating systems, on account of their improved corrosion resistance. The optical pigment properties are comparable with those of aluminum pigments produced by the conventional wet milling process.

JP 2003012964 A relates to a silane modification of polymer-coated aluminum pigments with leafing properties.

Excellent leafing properties are said to be possessed by the effect pigments described in U.S. Pat. No. 7,160,374 B2, where a layer of perfluoroalkyl phosphate or of silane has been applied to an adhesion promoter. These effect pigments find use for coatings or printing inks, on account of their gloss.

Furthermore, DE 10 054 981 A1 discloses hydrophobically aftercoated pearlescent pigment on the basis of a platelet-shaped substrate coated with metal oxides. The silane layer applied to the pigment surface is said to enhance the pigment properties, in respect, for example, of a reduction in swelling and blistering in water-based coating applications subject to condensation exposure.

Moreover, EP 1 084 198 B1 describes effect pigments with a surface modified with orientation assistants. The orientation assistant, which is present in monomeric or polymeric form, carries at least two different functional groups, which are separated from one another by a spacer. One of the functional groups is attached chemically to the pigment, while the other is able to react, for example, with the binder of the pigment-surrounding varnish in a kind of crosslinking reaction and hence to contribute to the stabilization of the pigment with nonleafing quality.

In contrast, DE 10 2005 037 611 A1 discloses metallic effect pigments with a hybrid inorganic/organic layer, possessing not only high mechanical stability but also good gassing stability. For this purpose, organic oligomers and/or polymers are joined to an inorganic network consisting of inorganic oxide components, the join being at least partly covalent via network formers. The network formers may inter alia be organo-functional silanes. The inorganic oxide component is constructed—when SiO₂ is present—from—for example—tetraalkoxysilanes.

EP 1 619 222 A1 discloses aluminum pigments having a silane-modified molybdenum- and silicon-oxide coating for water-based coating systems.

EP 1 655 349 A1 relates to recoatable effect powder coatings for good attachment of the clearcoat. These effect powder coatings comprise effect pigments which have been enveloped with a fluorine-containing polymer coating, but which do not afford adequate protection against destruction of the pigments under a shearing load. These pigments, therefore, can be incorporated only by the dry-blend or bonding method in the course of powder coating production.

DE 69927283 T2 discloses a powder coating composition with metallic effect exhibiting effect pigments, of aluminum or brass, for example. This powder coating composition pigmented with platelet-shaped metallic effect pigments further comprises a film-forming polymer and an additive which is composed of metal phosphate or metal borate and which is added to the composition during the homogenization phase, and/or by subsequent admixture, in order to inhibit the pigment decomposition induced by exposure to oxygen and water.

Conversely, JP62250074A relates to a water- and oil-repellent pigment for cosmetic applications, having a surface coating comprising fluoro alkyd amine phosphates.

JP2003213157A discloses a metallic pigment for a powder coating composition with a high metallic luster. This aluminum pigment, which can be employed in single-coat or multicoat powder coating finishes, is coated with at least one resin component containing a fluorinated alkyl group. The coated aluminum effect pigments disclosed therein are employed in the powder coating by means of dry-blending or by bonding.

JP2005187543A discloses a thermosetting powder composition. This composition comprises titanium dioxide powder and platelet-shaped aluminum pigments bonded and coated with fluoro resin.

Further pigment preparations which, as well as effect pigments and other ingredients, also contain surface-active substances, such as alkylsilanes, for example, are described comprehensively in DE 10 046 152A1, EP 1 104 447 B1, and EP 1 200 527 B1.

It is an object of the present invention to provide metallic effect pigments for powder coatings. These metallic effect pigments are to be suitable for use more particularly in powder coatings which are produced by mixing methods and have high abrasion stability and high-grade optical properties, especially in inexpensive single-coat finishes.

The object has been achieved by provision of metallic effect pigments with platelet-shaped metallic substrate, the metallic effect pigments having at least one metal oxide layer, the surface of the metal oxide layer having at least one surface modifier which comprises fluoroalkyl and/or fluoroaryl groups.

Preferred developments of the metallic effect pigments of the invention are indicated in dependent claims 2 to 12.

The object has further been achieved by provision of a method for producing the metallic effect pigments of the invention, said method being distinguished by the fact that the surface of the metal oxide layer is modified or coated with at least one surface modifier which comprises fluoroalkyl and/or fluoroaryl groups.

The object has been further achieved by provision of a powder coating comprising at least one binder and also a metallic effect pigment of the invention.

The object has further been achieved by provision of a method for producing a powder coating, which comprises the following steps:

a) coating or modifying a platelet-shaped substrate provided with a metal oxide layer with at least one surface modifier which comprises fluoroalkyl and/or fluoroaryl groups,
b) mixing, preferably extruding, the metallic effect pigment obtained in step a), together with binder and, optionally, further constituents of a powder coating,
c) grinding the extrudate obtained in step c).

The object on which the invention is based is further achieved by the use of metallic effect pigments of any of claims 1 to 12 in coatings, printing inks, cosmetic formulations, plastics or in powder coating.

The object of the invention is achieved, moreover, through the use of metallic effect pigments according to any of claims 1 to 12 for producing powder coatings by means of mixing methods, preferably by extruding a mixture of metallic effect pigments and powder coating binder and subsequently grinding the resulting extrudate.

In the context of this invention, methods for producing a powder coating that comprise the mixing, preferably the extrusion, of all of the components of the powder coating, including the metallic effect pigments of the invention, and also the subsequent grinding of the extrudate, are called “mixing methods”.

The metallic effect pigments of the invention comprise a platelet-shaped metallic substrate which is selected from the group consisting of aluminum, copper, zinc, tin, brass (gold bronze), iron, titanium, chromium, nickel, silver, gold, steel, and also their alloys and/or mixtures. Preferred in this context are aluminum, iron and/or brass.

These metallic effect pigments, produced by conventional ball mill grinding of atomized metal powder, have an average particle diameter of 1 to 200 μm, preferably 6 to 100 μm, and more preferably 8 to 75 μm, and also, preferably, an average particle thickness of 0.01 to 5.0 μm, preferably 0.02 to 2.0 μm, more preferably 0.05 to 1.0 μm.

Above an average size of 200 μm, the metallic effect pigments can no longer be used to good effect for the powder coating. Below 1 μm average size, the metallic effect achievable is generally no longer satisfactory.

The ratio of average particle diameter to average particle thickness (form factor) is preferably greater than 5, preferably greater than 20, more preferably greater than 50.

The metallic effect pigments of the invention are provided with a metal oxide coating which preferably envelops the metal platelets. According to one preferred variant of the invention, the at least one metal oxide layer has been applied to the platelet-shaped substrate by coating, i.e., in a separate step. The coating with metal oxides and/or metal oxide hydrates takes place preferably by precipitation or by sol-gel methods or by wet-chemical oxidation of the metal surface.

For the metal oxide coating it is preferred to use oxides, hydroxides and/or oxide hydrates of silicon, titanium, zirconium, iron, aluminum, cerium, chromium and/or mixtures thereof. In the case of high-refractive-index and/or colored oxides, such as TiO₂, Fe₂O₃, ZrO₂, and Cr₂O₃, for example, these metal oxide coatings cause the metallic effect pigment to impart color.

Yellowish to brownish metal pigments are also obtained by wet-chemical oxidation of aluminum pigments (DE 195 20 312 A1).

In the case of silicon oxides, silicon hydroxides or silicon oxide hydrates, and also in the case of aluminum oxides, aluminum hydroxides or aluminum oxide hydrates, the coated metallic effect pigments are protected against corrosive effects. This is particularly advantageous if the metallic effect pigments are arranged as leafing pigments, in the case of a single-coat finish, at the surface of the coating and are therefore particularly highly exposed to corrosive influences. Consequently, coatings of or with the oxides, hydroxides or oxide hydrates of silicon and aluminum are particularly preferred, and those of silicon are especially preferred.

According to one preferred variant of the invention the metallic effect pigments of the invention contain no molybdenum and/or no molybdenum oxide.

Furthermore, the metallic effect pigments may also have hybrid inorganic/organic layers, as are described in EP 1 812 519 A2.

Coatings of this kind stabilize the ductile metallic effect pigments from mechanical influences as well. Thus the mechanical stability of the metallic effect pigments is increased such that the pigments are not damaged or destroyed by the shearing forces that occur when the powder coating is produced by direct extrusion.

The thicknesses of the metal oxide layers, more particularly of the protective silicon oxide, aluminum oxide and/or hybrid inorganic/organic layers, are situated in the range from preferably 5 to 60 nm and more preferably from 10 to 50 nm.

The surfaces of the metallic effect pigments having at least one metal oxide layer are modified or coated with at least one surface modifier comprising fluoroalkyl and/or fluoroaryl groups.

This surface modifier comprises or consists of silanes, siloxanes, titanates, zirconates, aluminates, organic phosphoric acids or their esters, or of phosphonic acids or their esters.

Silanes, siloxanes, titanates, zirconates, and aluminates are understood in the sense of the invention to be organometallic compounds which have at least one fluoroalkyl and/or fluoroaryl group.

The organic phosphoric acids or their esters, and/or phosphonic acids or their esters, likewise have at least one fluoroalkyl and/or fluoroaryl group.

With particular preference the surface modifier comprises or consists of fluoroalkylsilanes and/or fluoroalkylsiloxanes, and very preferably fluoroalkyl-alkoxysilanes and/or fluoroalkylalkoxysiloxanes.

Compounds of this kind are able to attach with the alkoxysilane radical, as a result of the known processes of hydrolysis and condensation, very well to the metal oxide surface of the coated metallic effect pigment. The organic, fluorine-containing groups point away from the surface of the metallic effect pigment to the outer environment, i.e., to the application medium. The hydrophobic fluorine groups give the metallic effect pigment its leafing properties. Surprisingly, however, metallic effect pigments coated or modified in this way evidently still have sufficient interactions with the binder of the application medium to ensure effective abrasion resistance on the part of the metallic effect pigments in the cured coating.

Advantageously the surface modifier of the metallic effect pigments of the invention comprises or consists of fluoroalkyl- and/or fluoroaryl-group-containing silane of the general formula Si(Cl)ₓ(R_{c})_{y}(R_{f})_{4-x-y} or Si(OR)ₓ(R_{c})_{y}(R_{f})_{4-x-y}, where R is alkyl radical, R_{c} is alkyl radical and/or aryl radical, and Rf is fully or partly fluorinated alkyl and/or aryl radical, and x is 1, 2 or 3 and y is 0, 1 or 2. In one preferred embodiment x is 3 and y is 0.

The alkyl group R contains preferably 1 to 6 C atoms, more preferably 1 to 4 C atoms, and with particular preference is methyl or ethyl. The alkyl and/or aryl radical R_{c} contains preferably 1 to 24 C atoms, more preferably 1 to 18 C atoms, and the alkyl and/or aryl radical may contain heteroatoms, such as O, S, N. The alkyl radical contains preferably 1 to 6 C atoms and more preferably 1 to 2 C atoms. In the case of aryl, R_{c} is preferably phenyl or a phenyl derivative.

The fully or partly fluorinated alkyl radical R_{f} contains preferably 1 to 28 C atoms, more preferably 8 to 18 C atoms, and the fully or partly fluorinated alkyl radical R_{f} may contain heteroatoms, such as O, S, N.

Used with particular advantage are the following, commercially traded fluorosilanes:
1H,1H,2H,2H-perfluorodecyltrimethoxysilane
1H,1H,2H,2H-perfluorodecyltriethoxysilane
1H,1H,2H,2H-perfluorodecyltrichlorosilane
1H,1H,2H,2H-perfluorooctyltrimethoxysilane
1H,1H,2H,2H-perfluorooctyltriethoxysilane
1H,1H,2H,2H-perfluorooctyltrichlorosilane
1H,1H,2H,2H-perfluorooctylmethyldimethoxysilane
1H,1H,2H,2H-perfluorooctylmethyldiethoxysilane
1H,1H,2H,2H-perfluorooctylmethyldichlorosilane
(tridecafluoro-1,1,2,2-tetrahydrooctyl)trimethoxysilane
(tridecafluoro-1,1,2,2-tetrahydrooctyl)triethoxysilane
(tridecafluoro-1,1,2,2-tetrahydrooctyl)trichlorosilane
(heptadecafluoro-1,1,2,2-tetrahydrodecyl)trimethoxy-silane
(heptadecafluoro-1,1,2,2-tetrahydrodecyl)triethoxy-silane
(heptadecafluoro-1,1,2,2-tetrahydrodecyl)trichloro-silane
(3,3,3-trifluoropropyl)trimethoxysilane pentafluorophenylpropyltrimethoxysilane

Relevant commercial products are, for example, commercial products with the name Dynasylan™ F-8061-E, Dynasylan™ F-8261, Dynasylan™ F-8263, Dynasylan™ F-8815 from Degussa.

Additionally traded are products with the name Zonyl™ UR from DuPont, which comprise perfluorinated phosphoric esters.

These organo-functional silanes and/or siloxanes and/or phosphoric esters can be used as monomers, as oligomers or else as polymers for the surface modification.

According to one preferred variant of the invention, the applied surface modifier does not form an enveloping polymer coating. It has surprisingly emerged that even very small amounts of surface modifier are sufficient. The surface modifier in this case is applied preferably directly to the metal oxide surface without the use of a tie coat or coupling coat between metal oxide surface and surface modifier.

The surface modification is preferably in the form of a separate layer on the surface of the metal oxide coating, but can also be incorporated—at least in part—by copolymerization into the metal oxide coating, or may form a hybrid layer with the metal oxide coating.

The metallic effect pigments of the invention have a metal oxide content of 0.1% to 50%, preferably of 1% to 25%, more preferably of 3% to 15%, by weight. The amount of the additive comprising fluoroalkyl and/or fluoroaryl groups is situated preferably in a range from 0.1% to 10%, more preferably of 0.5% to 5%, very preferably of 0.75% to 3%, by weight, based in each case on the total pigment weight.

In a further advantageous embodiment of the invention, the surface modification of the metal oxide-coated metallic effect pigments may comprise further adjuvants, examples being organic and/or inorganic chromatic pigments, dyes, corrosion inhibitors and/or UV stabilizers.

The metallic effect pigments of the invention with a surface-modified metal oxide coating of preferably low film thickness can be produced inexpensively.

The surface modification can take place in a variety of ways. For example, the commercial surface modifier is dissolved in a commercial solvent, if desired under hydrolytic conditions as well, as for example in water in the presence of acidic or basic catalyst, and is subsequently applied to and dried on the metal-oxide-coated, platelet-shaped substrate. Alternatively the coating with the surface modifier may take place immediately after the platelet-shaped metallic substrate has been coated with at least one metal oxide layer, in a one-pot process.

It has surprisingly been found that the surface modifier adheres extremely reliably to the surface of the metal oxide coating of the metallic effect pigments of the invention, and is also stable with respect to the mechanical shearing forces that act on the pigments in the course of powder coating production by direct extrusion. Mechanical comminution of the pigments occurs, at the earliest, in the milling operation, but any fragments that may be formed in that operation continue to be coated with metal oxide layer and surface modifier, and therefore contribute to the high-grade optical appearance. These pigments, and the powder coating applications pigmented with these metallic effect pigments of the invention, also have better functional properties as compared with the powder coating applications pigmented with commercial metallic effect pigments.

As a result of the surface modification of the powder coating pigments of the invention with surface modifier comprising fluoro groups, these pigments surprisingly have a significantly higher abrasion resistance and better application stability, and also better optical properties, particularly in respect of metallic luster and metallic brightness, and also lightness, than commercially traded pigments, an example being PowderSafe products from Eckart.

The metallic effect pigments of the invention find use preferably in powder coatings with a pigment content of 0.1% to 50%, preferably of 0.2% to 15%, more preferably of 0.5% to 10%, by weight, based on the total powder coating weight.

The present invention further provides a method for producing metallic effect pigments according to claim 12, wherein the surface of the metal oxide coating enveloping the platelet-shaped metallic substrate, or of a metal-oxide-coated metallic effect pigment, is coated or modified with at least one surface modifier comprising fluoroalkyl and/or fluoroaryl groups, preferably with fluoroalkylsilane and/or fluoroalkyl-siloxane, and more preferably with fluoroalkylalkoxy-silane and/or fluoroalkylalkoxysiloxane.

The fluoroalkylalkoxysilanes and/or fluoroalkylalkoxy-siloxanes are brought to reaction with the metal oxide surface of the metallic effect pigments by hydrolysis and condensation steps.

The subject matter of the invention also relates to the use of the metallic effect pigments of the invention in paints, printing inks, cosmetic formulations, plastics, and powder coatings, more particularly in powder coatings produced by direct extrusion.

Furthermore, the powder coatings of the invention comprising the metallic effect pigments of the invention find use for the coating of substrates which comprise metal, metal foils, plastic, glass, glass fibers, composite materials, ceramic, wood, concrete, textile material, and woodbase materials, such as MDF boards, for example, or other materials suitable for decorative and/or protective purposes.

The invention also relates, furthermore, to a coated substrate coated with the powder coating of the invention or the metallic effect pigments of the invention.

The powder coating application of the invention may be coated with a single-layer or multilayer clearcoat.

A powder coating pigmented with metallic effect pigments of the invention and producible inexpensively by direct extrusion permits abrasion-stable, single-coat and multicoat powder coating applications with excellent metallic optical effects, especially as regards luster, brilliance, and lightness, which powder coating applications pigmented with commercial metallic effect pigments have hitherto been unable to achieve. Moreover, a powder coating of this kind of the invention has an application stability hitherto unachieved with powder coatings pigmented with metallic effect pigments—that is, in the course of application, there is no separation of the powder coating constituents that negatively impairs the surface optical qualities of the powder coating finish.

The invention further provides a method for producing a powder coating, which comprises the following steps:

a) coating a platelet-shaped metallic substrate provided with at least one metal oxide layer with at least one surface modifier which comprises fluoroalkyl and/or fluoroaryl groups,
b) mixing, preferably extruding, the coated metallic effect pigment obtained in step a) together with binder and, optionally, further constituents of a powder coating,
c) grinding the extrudate obtained in step b).

Prior to step a) it is possible optionally to carry out coating of the platelet-shaped metallic substrate with metal oxide.

The raw materials used for powder coating production by means of mixing methods, including the metallic effect pigments of the invention, if desired after separate premixing, are processed in a known way in an extruder in the melt into a homogeneous extrudate. The extrudate taken from the extruder, cooled, and comminuted is ground conventionally. Powder coating production in this way is described comprehensively in, for example, Pietschmann, J., Industrielle Pulverbeschichtung [Industrial powder coating], 1st edn., October 2002.

The powder coatings which can be produced particularly inexpensively by mixing methods and are pigmented by the metallic effect pigments of the invention may further comprise additional components such as fillers, additives, crosslinkers, pigments, and, if desired, other adjuvants.

The powder coatings pigmented with the metallic effect pigments of the invention can be employed with particular advantage in solvent-free applications in the form of eco-friendly primers or single-layer topcoats in numerous sectors of the metalworking industry, particularly of the automobile and automobile supplier industry, with a virtually complete degree of utilization.

In particular, the powder coating of the invention allows the overspray to be recycled and used again, without any adverse effect on the optical qualities of the coated article when the overspray is re-used as powder coating. Accordingly, the metallic effect pigments of the invention and the powder coating of the invention permit a hitherto unachieved yield in the powder coating procedure.

The invention is illustrated by reference to the examples set out below.

### Example 1

An inventive gold bronze pigment with surface fluoro-silane modification is prepared by dispersing 100 g of a silicate-coated gold bronze pigment (Dorolan 17/0 rich gold from ECKART) in 200 ml of acetone and carrying out surface modification by adding 2 g of Dynasylan F-8261 (3,3,4,4,5,5,6,6,7,7,8,8,8-trideca-fluorooctyltriethoxysilane) (from Degussa) and stirring the mixture at 40° C. for 4 h before filtering and drying. The inventive powder coating pigment is no different in optical qualities and particle size from the gold bronze pigment employed as starting material.

### Comparative Example 2

A conventional gold bronze pigment coated with metal oxide and surface-modified with alkylsilane is prepared as in example 1. For the surface modification of the pigment, rather than the commercial product Dynasylan F-8261, only the commercial product Dynasylan 9116 (hexadecyltrimethoxysilane) (from Degussa) is used.

### Comparative Example 3

Dorolan 17/0 pale gold: silicate-coated gold bronze effect pigment without silane aftertreatment. Available commercially from Eckart GmbH, Germany.

### Example 4

A further inventive, SiO₂-coated aluminum pigment with surface fluorosilane modification is prepared by dispersing 154 g of a commercial aluminum pigment paste (STAPA Metallic R 507 from ECKART) in 500 ml of ethanol in a 1 liter round-bottom flask equipped with reflux condenser and stirring apparatus. The mixture present is heated to 75° C. and 5 g of triethanolamine are added. Over the course of 8 hours a solution of 34.7 g of tetraethoxysilane in 34.7 g of ethanol is metered in. After the end of the addition, 4 g of Dynasylan™ F-8061-E (from Degussa) are metered in over the course of 2 hours for surface modification. The reaction mixture is slowly cooled and the pigment is separated off by filtration, washed with ethanol, and dried in a vacuum drying cabinet at 100 C.

### Example 5

A further inventive, SiO₂-coated aluminum pigment with surface fluorosilane modification is prepared by dispersing 100 g of a commercial, silicate-coated aluminum pigment (PCS 2000 from ECKART, average particle size approximately 20 μm) in 500 ml of acetone, adding 2 g of Dynasylan F-8261 (from Degussa) for surface modification, and stirring the mixture at a temperature of 40° C. for 4 hours, before then filtering and drying.

### Comparative Example 6

A conventional aluminum pigment with alkylsilane-surface-modified SiO₂ coating is prepared as in example 5. Instead of the Dynasylan™ F-8061-E (from Degussa) used for surface modification, only the commercial product Dynasylan 9116 (from Degussa) is used.

### Comparative Example 7

A further conventional aluminum pigment with only surface fluorosilane modification is prepared according to example 5. Instead of the commercial, silicate-coated aluminum pigment (PCS 2000 from Eckart), only a commercial, uncoated aluminum pigment (Stapa Metallic 501 from Eckart) having an average particle size of approximately 20 μm is used.

### Example 8

A further inventive aluminum pigment with surface fluoroalkylsilane modified SiO₂ coating is prepared according to example 5. Instead of the commercial, silicate-coated aluminum pigment (PCS 2000 from Eckart), only a commercial, silicate-coated aluminum pigment (PCS 5000 from ECKART) having an average particle size of approximately 50 μm is used.

### Comparative Example 9

PCS 2000: Silicate-coated aluminum effect pigment without further surface aftertreatment, having an average particle size of 20 μm. Available commercially from Eckart GmbH, Germany.

### Comparative Example 10

PCS 5000: Silicate-coated aluminum effect pigment without further surface aftertreatment, having an average particle size of approximately 50 μm. Available commercially from Eckart GmbH, Germany.

### Inventive and Comparative Examples 11-13

A gold-bronze-colored powder coating is produced by mixing 100 g of a commercial gold bronze pigment as per table 1 below with 900 g of a commercial powder clearcoat (AL96 from DuPont) and extruding the mixture in a screw extruder at 120° C. The extrudate is fractionated and processed using an impact feed mill into a powder coating. The powder coating is applied to Q-Panels (baking temperature: 200° C., baking time: 10 minutes). Colorimetry took place using a CM-508i colorimeter from Minolta. The abrasion resistance was determined qualitatively by rubbing with a cotton cloth (50 double rubs).

TABLE 1

| | | Optical | | | | |
|---|---|---|---|---|---|---|
| | | quality | | | | |
| | | (subjective | | | | Abrasion |
| Example | Pigment | impression) | L* | C* | H* | resistance |
| Example 11 | Pigment of | brilliant, | 60 | 30 | 69 | high |
| | example 1 | metallic | | | | |
| Comparative | Pigment of | brilliant, | 61 | 28 | 70 | low |
| example 12 | comparative | metallic | | | | |
| | example 2 | | | | | |
| Comparative | Pigment of | dark, | 45 | 18 | 62 | very high |
| example 13 | comparative | brownish | | | | |
| | example 3 | | | | | |

The powder coatings of example 11 and of comparative example 13 give high abrasion resistances. A comparison of the colorimetric properties, however, shows that high lightnesses L* and color strengths C* are obtained only in the case of examples 11 and 12. The pigments of comparative example 3 have to a large extent been destroyed in the powder coating after the grinding step on the extrudate. Since these pigments do not have leafing properties, the eventual optical impression is one which can hardly be called metallic.

Accordingly, only the pigments of the invention with metal oxide coating and also with a surface modification which contains fluoroalkyl groups exhibit both appealing optical qualities (high lightness, high brilliance) and good abrasion resistance.

### Inventive and Comparative Examples 14-20

A powder coating pigmented with aluminum pigments is produced by mixing 100 g of an aluminum pigment as per table 2 below with 900 g of a commercial powder clearcoat (AL96 from DuPont) and extruding the mixture in a screw extruder at 120° C. The extrudate is fractionated and processed using an impact feed mill into a powder coating. The powder coating is applied to Q-Panels (baking temperature: 200° C., baking time: 10 minutes). Colorimetry of the applied powder coating takes place using a CM-508i colorimeter from Minolta. The abrasion resistance of the applied powder coating is determined qualitatively by rubbing with a cotton cloth (50 double rubs).

TABLE 2

| Inventive or | | | | |
|---|---|---|---|---|
| comparative | | Optical | | Abrasion |
| example | Pigment type | qualities | L | resistance |
| 14 | Pigment of example 4 | brilliant, | 76 | high |
| | | metallic | | |
| 15 | Pigment of example 5 | brilliant, | 76 | high |
| | | metallic | | |
| 16 | Pigment of | brilliant, | 76 | low |
| | comparative example 6 | metallic | | |
| 17 | Pigment of | dark, gray | 52 | very high |
| | comparative example 7 | | | |
| 18 | Comparative example 9: | dark, gray | 55 | very high |
| | PCS 2000 (without | | | |
| | silane treatment) | | | |
| 19 | Pigment of example 8 | brilliant, | 80 | high |
| | | metallic, | | |
| | | sparkly | | |
| 20 | Comparative example 10: | dark, | 61 | very high |
| | PCS 5000 (without | little | | |
| | silane treatment) | sparkle | | |

The values in table 2 demonstrate that the powder coating applications comprising metallic effect pigments of the invention have substantially improved optical qualities with regard to metallic brilliance and lightness, and also better abrasion resistance, than powder coatings with conventional metallic effect pigments without surface fluorosilane modification.

Furthermore, comparative example 17, comprising a powder coating which is a fluoroalkylsilane-treated aluminum pigment that has no metal oxide layer, does not have good optical properties. Here, as a result of the mechanical forces occurring in extrusion and, subsequently, in grinding, the metal pigment was damaged to such a severe extent that appealing optical properties are no longer obtained.

The alkylsilane-treated aluminum pigments do display good optical properties in the powder coating, induced by the floating of pigments which in mechanical terms are largely undamaged. In this case, however, the abrasion resistance is low (comparative example 16).

1. Metallic effect pigments with a platelet-shaped metallic substrate, the metallic pigments having at least one metal oxide layer, wherein
the surface of the metal oxide layer has at least one surface modifier which comprises at least one of fluoroalkyl and/or and fluoroaryl groups.

2. The metallic effect pigments of claim 1, wherein
the platelet-shaped metallic substrate comprises at least one selected from the group consisting of aluminum, copper, zinc, tin, gold bronze, brass, iron, titanium, chromium, nickel, silver, gold steel, and alloys and/or and mixtures of these metals.

3. The metallic effect pigments of claim 1, wherein
the metallic effect pigments have an average particle diameter of 1 to 200 μm.

4. The metallic effect pigments of claim 1, wherein
the metallic effect pigments have an average particle thickness of 0.01 to 5.0 μm.

5. The metallic effect pigments of claim 1, wherein
the metallic effect pigments have a ratio of average particle diameter to average particle thickness of greater than 5.

6. The metallic effect pigments of claim 1, wherein
the metal oxide coating envelops the platelet-shaped substrate.

7. The metallic effect pigments of claim 1, wherein
the at least one metal oxide layer has been applied to the platelet-shaped substrate by coating.

8. The metallic effect pigments of claim 1, wherein
the surface modifier comprises at least one selected from the group consisting of silane, siloxane, titanate, zirconate, aluminate, phosphoric ester and phosphonic acid.

9. The metallic effect pigments of claim 1, wherein
the surface modifier comprises at least one of fluoroalkylsilane and fluoroalkylsiloxane.

10. The metallic effect pigments of claim 1, wherein
the surface modifier applied to the metal oxide surface comprises or consists of compounds which have the general formula.
Si(Cl)ₓ)_{y}(R_{c})_{y}(R_{f})_{4-x-y}
or
Si(OR)ₓ(R_{c})_{y}(R_{f})_{4-x-y},
where
R is alkyl radical having 1 to 6 C atoms,
R_{c} is at least one of an alkyl radical and an aryl radical having 1 to 24 C atoms, wherein said at least one of an alkyl and an aryl radical optionally contains at least one heteroatom, R_{f} is at least one selected from the group consisting of fully and partly fluorinated alkyl and aryl radicals having 1 to 28 C atoms, wherein the at least one of said fully and partially fluorinated alkyl and aryl radicals optionally contains at least one heteroatom,
x is 1, 2 or 3 and y is 0, 1 or 2.

11. The metallic effect pigments of claim 1, wherein
the metallic effect pigments have a metal oxide content of 0.1% to 50% based on the total weight of the metallic effect pigment.

12. The metallic effect pigments of claim 1, wherein
the metallic effect pigments have a surface modifier content of 0.1% to 10%, based on the total weight of the metallic effect pigment.

13. A method for producing metallic effect pigments as claimed in claim 1,
wherein
the surface of the metal oxide layer is coated with at least one surface modifier which comprises at least one of fluoroalkyl and fluoroaryl groups.

14. A method for forming a material selected from the group consisting of coating materials, printing inks, cosmetic formulations and plastics, wherein the method comprises including metallic effect pigments according to claim 1 in said material.

15. A method of forming a powder coating, wherein the method comprises including in a coating powder used to form said coating the metallic effect pigments claimed in claim 1.

16. A method for forming a powder coating, wherein said method comprises extruding a mixture of metallic effect pigments as claimed in claim 1 and powder coating binder and subsequently grinding the resulting extrudate.

17. A powder coating comprising at least one binder and at least one metallic effect pigment of claim 1.

18. A method for producing a powder coating,
which comprises the following steps:
a) coating a platelet-shaped metallic substrate provided with at least one metal oxide layer with at least one surface modifier which comprises at least one of fluoroalkyl and fluoroaryl groups,
b) mixing the coated metallic effect pigment obtained in step a) together with binder and, optionally, further constituents of a powder coating, and
c) grinding the extrudate obtained in step b).

19. A method for coating substrates selected from the group consisting of metal, metal foils, plastic, glass, glass fibers, composite materials, ceramic, wood, concrete, textile material, and woodbase materials, wherein the method comprises coating said substrate with a powder coating comprising at least one metallic effect pigment as claimed in claim 1.

20. A coated substrate
wherein
the substrate is coated with metallic effect pigments as claimed in claim 1 or with a powder coating comprising said metallic effect pigments.

21. The metallic effect pigments of claim 3, wherein the metallic effect pigments have an average particle diameter of 6 to 100 μm.

22. The metallic effect pigments of claim 3, wherein the metallic effect pigments have an average particle diameter of 8 to 75 μm.

23. The metallic effect pigments of claim 4, wherein the metallic effect pigments have an average particle thickness of 0.02 to 2.0 μm.

24. The metallic effect pigments of claim 4, wherein the metallic effect pigments have an average particle thickness of 0.05 to 1.0 μm.

25. The metallic effect pigments of claim 5, wherein the metallic effect pigments have a ratio of average particle diameter to average particle thickness of greater than 20.

26. The metallic effect pigments of claim 5, wherein the metallic effect pigments have a ratio of average particle diameter to average particle thickness of greater than 50.

27. The metallic effect pigments of claim 6, wherein the enveloping metal oxide coating comprises at least one of oxides and oxide hydrates of silicon, titanium, zirconium, iron, aluminum, cerium, chromium and mixtures thereof.

28. The metallic effect pigments of claim 10, wherein said at least one heteroatom is selected from the group consisting of O, S and N.

29. The metallic effect pigments of claim 11, wherein the metallic effect pigments have a metal oxide content of 1% to 25% by weight, based on the total weight of the metallic effect pigment.

30. The metallic effect pigments of claim 11, wherein the metallic effect pigments have a metal oxide content of 3% to 5% by weight, based on the total weight of the metallic effect pigment.

31. The metallic effect pigments of claim 12, wherein the metallic effect pigments have a surface modifier content of 0.5% to 5%, based on the total weight of the metallic effect pigment.

32. The metallic effect pigments of claim 12, wherein the metallic effect pigments have a surface modifier content of 0.75% to 3% by weight, based on the total weight of the metallic effect pigment.

33. The method for producing a powder coating of claim 18, wherein the mixing in step (b) is obtained by extruding the coated metallic effect pigment obtained in step (a) together with binder and, optionally, further constituents of said powder coating.
